(19) United States
(12) Patent Application Publication
(10) Pub. No.: US 2016/0300243 A1
(43) Pub. Date: Oct. 13, 2016

(54) DETERMINING RANKING THRESHOLD FOR APPLICATIONS

(71) Applicant: BEIJING ZHIGU RUI TUO TECH CO., LTD, Beijing (CN)

(72) Inventors: Kuifei Yu, Beijing (CN); Hengshu Zhu, Beijing (CN)

(21) Appl. No.: 15/026,961

(22) PCT Filed: Oct. 9, 2014
(86) PCT No.: PCT/CN2014/088238

§ 371 Date: Apr. 1, 2016

(30) Foreign Application Priority Data
Oct. 10, 2013 (CN) 201310470186.2

(51) Int. Cl. G06Q 30/00; G06F 17/30

(52) U.S. Cl. CPC G06Q 30/0185; G06F 17/3053

(57) ABSTRACT

The present application provides a method for determining a ranking threshold for applications and a system for determining a ranking threshold for applications. The method comprises: a user attention behavior detection step: detecting an attention behavior of a user towards an application leaderboard to obtain user attention behavior data; and a ranking threshold determining step: determining a ranking threshold according to the user attention behavior data. According to the method and the system in the present application, an actual user attention application quantity on an application leaderboard can be determined effectively, which provides a determination basis for detection of ranking fraud and increases efficiency and accuracy of detection of ranking fraud.

### RELATED APPLICATION

The present international patent cooperative treaty (PCT) application claims the benefit of priority to Chinese Patent Application No. 201310470186.2, filed on Oct. 10, 2013, and entitled “Method for Determining Ranking Threshold for Applications and System for Determining Ranking Threshold for Applications”, which is hereby incorporated into the present international PCT application by reference herein in its entirety.

### TECHNICAL FIELD

The present application relates to the network field, and in particular, to a determining a ranking threshold for applications.

### BACKGROUND

User applications, especially mobile applications installed and configured to run on mobile terminals, have been developing rapidly in recent years. To make it convenient for a user to select and install an application, many application websites or application stores provide, in a centralized manner, services such as search, download, and comment of applications, and also release regularly, for example, daily, an application leaderboard to indicate some applications currently popular among users. A user may log in, by using a personal computer, to an application website or log in, by using a mobile terminal, to a mobile client of an application store to browse the application leaderboard, and select to purchase or download a favorite application from the application leaderboard.

In fact, the application leaderboard is a recognized measure for promoting an application. An application ranked high in a leaderboard usually stimulates download of the application by a great number of users, and brings great economic gains to an application developer. Therefore, application developers hope that their applications have higher ranks in a leaderboard. As a result, ranking fraud is committed for this purpose. Ranking fraud of an application refers to a fraud behavior made to improve the rank of the application on an application leaderboard. In fact, instead of relying on conventional marketing measures to make the rank of an application higher, it becomes a common behavior for application developers to commit ranking fraud by exaggerating product sales or releasing false product comments, for example, by hiring human water armies to increase the number of downloads of an application and comments on an application.

The industry has become aware of the importance of preventing ranking fraud so that application users obtain real ranking information of an application. In order to prevent ranking fraud of an application, a conventional method is that an application store operator detects abnormal rises of ranks or abnormal comments of users of all applications one by one. However, due to the large number of applications and the continuous increase of the number, this manner consumes a large amount of resources and is inefficient. Conventionally, a ranking threshold K* has been set as a standard for popularity of an application among users, and only applications once in the top K* on an application leaderboard are detected (those never in the top K* in a leaderboard are considered to be unlikely to involve ranking fraud and therefore do not need to be detected). In this way, the amount of detected applications has been reduced.

However, conventionally, an application store operator usually determines the value of the ranking threshold K* according to a subjective experience without considering an actual attention behavior of a user towards an application leaderboard, which makes it difficult to determine a quantity of applications that are actually popular among users on the application leaderboard and also affects accuracy of a detection result of ranking fraud.

### SUMMARY

An objective of the present application is to provide a technology for determining a ranking threshold for applications, so as to effectively determine an actual user attention application quantity on an application leaderboard, thereby providing a determination basis for detection of ranking fraud and improving efficiency and accuracy of detection of ranking fraud.

According to one aspect of the present application, a method for determining a ranking threshold for applications is provided, wherein the method comprises:

a user attention behavior detection step: detecting an attention behavior of a user towards an application leaderboard to obtain user attention behavior data; and

a ranking threshold determination step: determining a ranking threshold according to the user attention behavior data.

According to another aspect of the present application, a system for determining a ranking threshold for applications is further provided, wherein the system comprises:

a user attention behavior detection module, configured to detect an attention behavior of a user towards an application leaderboard to obtain user attention behavior data; and

a ranking threshold determination module, configured to determine a ranking threshold according to the user attention behavior data.

According to the method and the system in the present application, an actual user attention application quantity on an application leaderboard can be determined effectively, which provides a determination basis for detection of ranking fraud and increases efficiency and accuracy of detection of ranking fraud.

### BRIEF DESCRIPTION OF THE DRAWINGS

The disclosure will become more fully understood from the detailed description given herein below for illustration only, and thus are not limitative of the disclosure, and wherein:

FIG. 1 is a flowchart of a method for determining a ranking threshold for applications according to an embodiment of the present application;

FIG. 2 is a system structural diagram of a system for determining a ranking threshold for applications according to an embodiment of the present application; and

FIG. 3a shows an example of a leading event on an application leaderboard according to an embodiment of the present application;

FIG. 3b shows an example of a leading session on an application leaderboard according to an embodiment of the present application; and

FIG. 4 is a schematic structural diagram of a system for determining a ranking threshold for applications according to another embodiment of the present application.

### DETAILED DESCRIPTION

Embodiments of the present application are further described in detail in the following with reference to the accompanying drawings and embodiments. The following embodiments are used for describing the present application rather than limiting the scope of the present application.

The present application focuses on the study of technical problems related to ranks of applications. Therefore, a person skilled in the art should construe “application” in the present application as a broad concept, which comprises various programs or files that can be released on the Internet and can be downloaded, commented, or executed by users, that is, comprises a conventional application run in a personal computer and a mobile application run in a mobile terminal and also comprises a multimedia file, such as a picture, audio, and a video, that can be downloaded and played.

The present application provides a technology through which a ranking threshold for applications can be determined. In this technology, an attention behavior of an application user towards an application leaderboard may be detected to obtain data related to the attention behavior of the user, and a ranking threshold is determined based on the user attention behavior data.

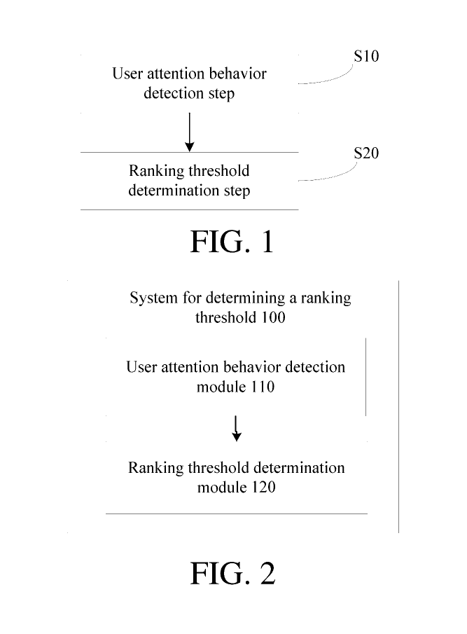

As shown in FIG. 1, an embodiment of the present application provides a method for determining a ranking threshold for applications, wherein the method comprises:

a user attention behavior detection step S10: detecting an attention behavior of a user towards an application leaderboard to obtain user attention behavior data; and a ranking threshold determination step S20: determining a ranking threshold according to the user attention behavior data.

Processes and functions of the steps of the foregoing method for determining a ranking threshold in the embodiment of the present application are described in the following with reference to the accompanying drawings.

User attention behavior detection step S10: Detect an attention behavior of a user towards an application leaderboard to obtain user attention behavior data.

As described in the foregoing, a user may log in, by using a personal computer, to an application website or log in, by using a mobile terminal, to a mobile client of an application store to browse the application leaderboard, and select to purchase or download a favorite application from the application leaderboard. In order to determine a ranking threshold K*, data should be collected from user behaviors such as browsing of the application leaderboard and downloading from the application leaderboard by a great number of users, and a statistical result is obtained, so that the ranking threshold K* reflects a quantity of applications that are actually popular among common users on the application leaderboard.

As an embodiment, the user attention behavior data in the present application may be represented by a binary array sequence [symbol] U, K [symbol] ={ [symbol] u₁, k₁ [symbol] , [symbol] u₂, k₂ [symbol] , . . . [symbol] uₙ, kₙ [symbol] }, wherein each binary array [symbol] uᵢ, kᵢ [symbol] i ∈ [1,n] represents a piece of user attention behavior data obtained from a user end or device, where uᵢ is a user identifier, kᵢ is a user attention application quantity obtained from the user uᵢ, and n is the total number of pieces of obtained user attention behavior data. A person skilled in the art may understand that the user identifier uᵢ can be used for identifying user attention behavior data of different users, but in a case in which user attention behavior data obtained multiple times from a same user are calculated repeatedly, in the user attention behavior data, a user identifier may be omitted and only a user attention application quantity is comprised, so that a sequence K={k₁, k₂, . . . , kₙ} of the user attention behavior data is formed.

The obtaining of the user attention behavior data may comprise a user identifier obtaining step, used for obtaining the user identifier uᵢ. Because the value of the user identifier uᵢ may be an inherent identifier of the user (for example, a network ID of the user) and can therefore be directly obtained from a user end, or may be determined by a service provider of an application website or an application store when the user attention application quantity kᵢ is obtained (for example, the service provider provides a serial number), the key to obtaining of the user attention behavior data lies in obtaining of the user attention application quantity kᵢ. Therefore, the user attention behavior detection step may further comprise a user attention application quantity obtaining step, used for obtaining the user attention application quantity kᵢ.

As an embodiment of the user attention application quantity obtaining step, a corresponding functional module may be set in a user client (a personal computer or a mobile terminal), a data layer of the user client records a rank, of an application, which is requested by a presentation layer, on the application leaderboard, and then the rank of the application is used as a user attention application quantity and sent to a server end of a service provider, and a receiving module of the server end receives the user attention application quantity.

Specifically, when a user logs in, by using a personal computer, to an application website to browse the application leaderboard, a single webpage usually cannot simultaneously display all applications on the application leaderboard. In this case, after browsing on the first page a certain number of applications ranked top, the user may turn the page to browse more applications until the user determines an application that interests the user and executes a particular user operation on the application (for example, clicks a “Details” button to learn detailed information about the application, or clicks a “Download” button to download the application). In this case, the rank of the application may be used as a user attention application quantity and sent to a server end of a service provider, and a receiving module of the server end receives the user attention application quantity. For example, in a webpage sequence of an application leaderboard with each page displaying 100 applications, if the user turns to the second page and downloads the 50^{th} application, a user attention application quantity this time is 150.

When a user logs in, by using a mobile terminal, to a mobile client of an application store to browse the application leaderboard, due to the limit of the size of a screen of an intelligent terminal, only a few applications (for example, 10) pushed by a service provider on the application leaderboard can be displayed. In this case, the user needs to perform an action, for example, slide up on the screen, to browse more applications, and the service provider pushes a list including more applications to the user in response to the action of the user until the user determines an application that interests the user and executes a particular user operation on the application (for example, clicks the name of the application to learn detailed information about the application, or clicks a “Download” button to directly download the application). In this case, the rank of the application may be used as a user attention application quantity and sent to a server end of the service provider, and a receiving module of the server end receives the user attention application quantity. For example, when the user slides to the 45^{th} application and downloads the 45^{th} application, a user attention application quantity this time is 45.

As another embodiment of the user attention behavior data obtaining step, a recording module may also be set in a server end of a service provider; a leaderboard browsing session with a user client is used as a unit, and a quantity of applications pushed to the user client in a leaderboard browsing session is recorded and used as the user attention application quantity.

Specifically, when a user logs in, by using a personal computer, to an application website to browse the application leaderboard, after browsing on the first page, a certain number of applications may be ranked top, the user may turn the page to browse more applications until the user determines an application that interests the user and executes a particular user operation on the application. In this case, a lowest rank of an application displayed on a current page may be used as a user attention application quantity. For example, in a webpage sequence of an application leaderboard with each page displaying 100 applications, if the user turns to the second page and downloads the 50^{th} application, a user attention application quantity is a lowest rank 200 of an application on the second page.

When a user logs in, by using a mobile terminal, to a mobile client of an application store to browse the application leaderboard, the user performs an action, for example, slides up on the screen, to browse more applications, and a service provider pushes a list including more applications to the user in response to the action of the user until the user determines an application that interests the user and executes a particular user operation on the application. In this case, a lowest rank of an application currently displayed on a screen of the mobile terminal may be used as a user attention application quantity. For example, if the user downloads the 45^{th} application when the mobile terminal displays the 50^{th} application, in this case, a user attention application quantity this time is 50.

Ranking threshold determination step S20: Determine a ranking threshold according to the user attention behavior data.

An objective of determining the ranking threshold K* in the present application is to determine an actual user attention application quantity on the application leaderboard. Therefore, applications ranked top K* on the application leaderboard should cover most of applications that currently draw attention from users or cover most of users who pay attention to applications. A person skilled in the art may understand that because attention behaviors of users towards an application leaderboard are different, the quantities of applications drawing attention from the users vary greatly, and some users browse a majority or even all of applications on an application leaderboard while some users only browse a few applications on an application leaderboard. In this case, if it is expected that all applications that currently draw attention from users are covered or all users who currently pay attention to applications are covered (a coverage rate reaches 100%), it should be determined that the ranking threshold K* is a very large value, which is not beneficial for subsequent application of the ranking threshold K* or even makes the determination of the ranking threshold K* meaningless; in contrast, if the ranking threshold K* is determined to be a very small value (a coverage rate is very small), most of applications that currently draw attention from users cannot be covered or most of users who currently pay attention to applications cannot be covered, and therefore, an actual user attention application quantity on the application leaderboard cannot be determined

Therefore, in the embodiment of the present application, a parameter needs to be set to determine a coverage proportion of applications that currently draw attention from users or a coverage proportion of users who currently pay attention to applications, and the parameter is used as a standard to determine the value of the ranking threshold. In the present application, the parameter is referred to as a “coverage parameter”. Preferably, the ranking threshold determination step further comprises a coverage parameter setting step, used for setting the coverage parameter. Considering that most of applications that actually draw attention from users should be covered or most of users who currently pay attention to applications should be covered, a value range of the coverage parameter may be 60% to 90%.

In an embodiment, the coverage parameter is a coverage proportion of user attention application quantities in the user attention behavior data, and in the ranking threshold determination step, the ranking threshold is determined so that applications not lower than the ranking threshold on the application leaderboard cover user attention applications having the proportion of the coverage parameter in the user attention behavior data.

Specifically, the ranking threshold may be determined in the following manner:

Step 21: Calculate the total number T of user attention application quantities in the user attention behavior data.

Step 22: Set an initial value of K* to a small value, for example, K*=1.

Step 23: Calculate the total number Y of user attention application quantities, which can be covered by a current value of K*, in the user attention behavior data.

Step 24: Calculate Y/T and compare Y/T and the coverage parameter X, if Y/T reaches the coverage parameter X, output K* as the determined ranking threshold, and if Y/T does not reach the coverage parameter X, add 1 to K*, and return to step 23.

Step 23 may further comprise the following steps:

Step 231: Set Y=0.

Step 232: Sequentially compare all user attention application quantities in the user attention behavior data and a current ranking threshold K*, if K*<kᵢ, add K* to Y, and otherwise, add kᵢ.

Step 233: Output Y.

The foregoing steps may be represented by, for example, the following pseudo program code:

```
“let <U, K> as the detected user behavior data; //Detected user
attention behavior data;
T= sum(K);
let K* = 1;
let Y= 0;
while(1):
  for each [symbol]   uᵢ,kᵢ [symbol]   in <U, K>:
      if K*<kᵢ:
        Y+= K*;
      else:
        Y+= kᵢ ;
    if Y /T< X;
      K*++;
      Y=0;
  return K*; //Scan applications ranked top K*, and at least X of
applications drawing attention from users are covered”
```

It can be seen that the ranking threshold K* obtained according to the foregoing steps satisfies that applications not lower than the ranking threshold K* on the application leaderboard cover user attention applications having the proportion of the coverage parameter. For example, when the coverage parameter is 80% and it is determined that the ranking threshold is 300, as long as the top 300 applications on the application leaderboard are considered, 80% of all applications drawing attention from all users in the user attention behavior data can be covered.

In another embodiment, the coverage parameter is a coverage proportion of user identifiers in the user attention behavior data, and in the ranking threshold determination step, the ranking threshold is determined so that applications not lower than the ranking threshold on the application leaderboard cover applications drawing attention from users having the proportion of the coverage parameter in the user attention behavior data.

Specifically, the ranking threshold may be determined in the following manner:

Step 21: Calculate the total number T of user identifiers in the user attention behavior data.

Step 22: Calculate the number T×X, which satisfies the coverage parameter X, of user identifiers that need to be covered.

Step 23: Sort user attention application quantities in the user attention behavior data in an ascending order, and use the sorted (T×X)^{th} user attention application quantity as the ranking threshold K*.

It can be seen that the ranking threshold K* obtained according to the foregoing steps satisfies that applications not lower than the ranking threshold K* on the application leaderboard cover applications drawing attention from users having the proportion of the coverage parameter. For example, when the coverage parameter is 80% and it is determined that the ranking threshold is 300, as long as the top 300 applications on the application leaderboard are considered, all applications drawing attention from 80% of users in the user attention behavior data can be covered.

As shown in FIG. 2, another embodiment of the present application further provides a system 100 for determining a ranking threshold for applications, wherein the system 100 comprises:

a user attention behavior detection module 110, configured to detect an attention behavior of a user towards an application leaderboard to obtain user attention behavior data; and a ranking threshold determination module 120, configured to determine a ranking threshold according to the user attention behavior data.

Functional modules of the foregoing system for determining a ranking threshold in the embodiment of the present application are described in the following with reference to the accompanying drawings.

A user attention behavior detection module 110 is configured to detect an attention behavior of a user towards an application leaderboard to obtain user attention behavior data.

Preferably, the user attention behavior detection module 110 may comprise a user identifier obtaining unit, configured to obtain a user identifier uᵢ.

Preferably, the user attention behavior detection module 110 may comprise a user attention application quantity obtaining unit, configured to obtain a user attention application quantity kᵢ.

As an embodiment of the user attention application quantity obtaining unit, a data layer of a client may record a rank, which is requested by a presentation layer, of an application, and then the rank of the application is used as a user attention application quantity and sent to a server end of a service provider, and the server end receives the user attention application quantity. As another embodiment of the user attention application quantity obtaining unit, a server end of a service provider may record a quantity of applications pushed in a leaderboard browsing session to a user client, and the quantity is used as the user attention application quantity.

A ranking threshold determination module 120 is configured to determine a ranking threshold according to the user attention behavior data.

Preferably, the ranking threshold determination module 120 may comprise a coverage parameter setting unit, configured to set a coverage parameter. Considering that most of applications that actually draw attention from users should be covered or most of users who currently pay attention to applications should be covered, a value range of the coverage parameter may be 60% to 90%.

In an embodiment, the coverage parameter is a coverage proportion of user attention application quantities in the user attention behavior data, and the ranking threshold determination module 120 is configured to determine the ranking threshold so that applications not lower than the ranking threshold on the application leaderboard cover user attention applications having the proportion of the coverage parameter in the user attention behavior data.

In another embodiment, the coverage parameter is a coverage proportion of user identifiers in the user attention behavior data, and the ranking threshold determination module 120 is configured to determine the ranking threshold so that applications not lower than the ranking threshold on the application leaderboard cover applications drawing attention from users having the proportion of the coverage parameter in the user attention behavior data.

As one of technical effects of the present application, most directly, according to the determined ranking threshold K* in the foregoing embodiment of the present application, a quantity of applications that interest common users on the application leaderboard can be learned, and a leading session, during which ranking fraud may occur, of an application is detected, thereby detecting ranking fraud. Besides, according to the ranking threshold K*, needs of users to pay attention to applications on an application leaderboard can be determined, so that for a few applications that are actually popular among users, better application services are pushed to users (for example, more additional information is provided for applications ranked top K*), or even a basis for rating and allocation of advertisement fees may be provided according to the ranking threshold K*.

A specific application scenario of the determined ranking threshold K* in the embodiment of the present application is described in the following by using detection of a leading session of an application as an example.

The applicant finds through analysis that an application involving ranking fraud does stay long at a high rank on a leaderboard, and a case in which an application is ranked high only occurs as some independent events within a relatively short period of time, which indicates that a ranking fraud behavior occurs exactly within this period of time. A period of time during which an application is continuously ranked high may be referred to as a “leading event”, and a period of time during which leading events frequently occur may be referred to as a “leading session”.

An application leaderboard usually can display popular applications ranked top K, for example, top 1000. Besides, the application leaderboard is usually updated regularly, for example, is updated daily. Therefore, each application a has historical ranking information, wherein the historical ranking information may be represented by a ranking sequence Rₐ={r₁^{a}, . . . , rᵢ^{a}, . . . , rₙ^{a}} corresponding to a discrete-time sequence, and a fixed interval, that is, an update period of the application leaderboard, exists between time points in the discrete-time sequence, where rᵢ^{a} is the rank of the application a at time tᵢ, rᵢ^{a} ∈ {1, . . . , K . . . , +∞}, +∞ indicates that the application a is not among the top K on the leaderboard, and n indicates the total number of all time points corresponding to the historical ranking information. For example, in a case in which the leaderboard is updated daily, tᵢ represents the i^{th} day in this period of history, and n is the total number of days corresponding to historical ranking information. It can be seen that a smaller value of rᵢ^{a} indicates a higher rank of the application a on the i^{th} day on the leaderboard.

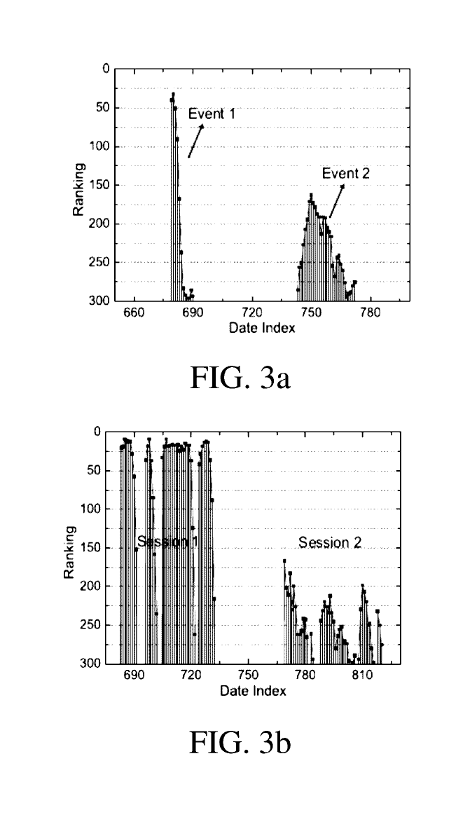

It is found through analysis that an application usually does not stay at a high rank on a leaderboard, and a period during which the application is continuously ranked high is a “leading event”. FIG. 3a shows an example of a leading event of an application, in which a horizontal axis indicates a time sequence (Date Index) corresponding to historical ranking information, and a vertical axis indicates the rank of the application. An event 1 and an event 2 in FIG. 3a represent two leading events that occur in a ranking history of the application, and profiles of the leading events are separately connected by ranking points during periods of the leading events.

A standard for a high rank of an application on an application leaderboard is that a rank of the application does not exceed the determined ranking threshold K* in the embodiments of the present application. Because an application is considered to have a high rank if the application is ranked top K* on a leaderboard, a period of time during which the application is continuously ranked top K* may be considered as a leading event, and the leading event should start when the application starts to be ranked top K* on the leaderboard and last until the application drops out of the top K* on the leaderboard. In FIG. 2a, that the value of K* is 300 is used as an example.

According to the foregoing text description of a leading event, a leading event e of an application a may be described through formulas as follows:

Given that the ranking threshold K* is used as a standard for a high rank, where K* ∈ [1, K]; the leading event e of the application a comprises a time range Tₑ=[tₛₜₐᵣₜ^{e}, t_{end}^{e}] from a start time to an end time, and correspondingly, the rank of the application a satisfies rₛₜₐᵣₜ^{a}≦K*<rₛₜₐᵣₜ₋₁^{a} and r_{end}^{a}≦K*<r_{end-1}^{a}, and ∀tₖ ∈ (tₛₜₐᵣₜ^{e}, t_{end}^{e}) also satisfies rₖ^{a}≦K*.

It can be seen from the foregoing description that detection of a leading event is detection of a start time and an end time of a period of time during which an application is continuously ranked top K*, and a period of time between the start time and the end time is determined as a leading event.

After leading events are determined, adjacent leading events may be combined in the leading session detection step to form the leading session. It is found through further research that for some applications, multiple leading events that are adjacent to each other occur continually within a period of time, and this period of time is the “leading session” of the application in the present application. It can be seen that a leading session is formed of adjacent leading events.

FIG. 3b shows an example of a leading session of an application, in which a horizontal axis indicates a time sequence (Date Index) corresponding to historical ranking information, and a vertical axis indicates a rank of the application. A session 1 and a session 2 in FIG. 3b represent two leading sessions that occur in a ranking history of the application, and each leading session is formed of multiple leading events.

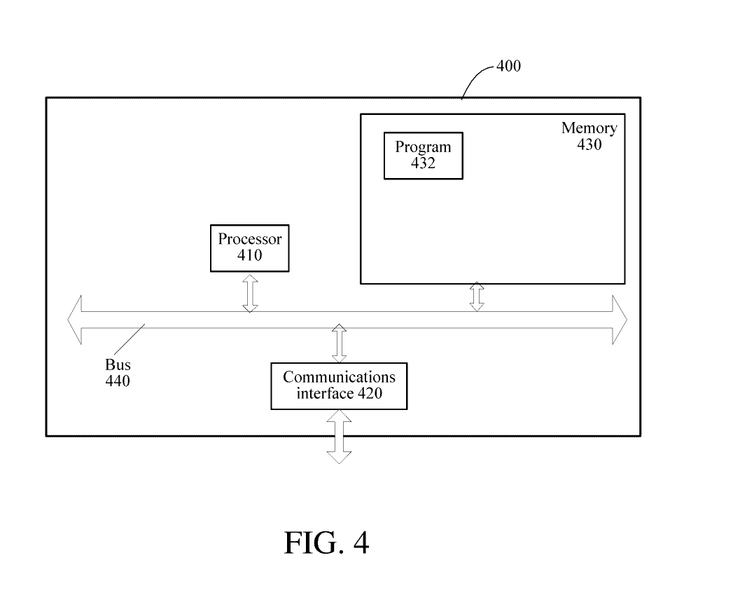

FIG. 4 is a schematic structural diagram of a system 400 for determining a ranking threshold for applications. Specific implementation of the system 400 for determining a ranking threshold is not limited in specific embodiments of the present application. As shown in FIG. 4, the system 400 for determining a ranking threshold may comprise:

a processor 410, a communications interface 420, a memory 430, and a communications bus 440, wherein

the processor 410, the communications interface 420, and the memory 430 communicate with each other through the communications bus 440.

The communications interface 420 is configured to communicate with a network element such as a client.

The processor 410 is configured to execute a program 432, which may specifically implement related functions of the system for determining a ranking threshold in the embodiment in FIG. 2.

Specifically, the program 432 may comprise program code, wherein the program code comprises a computer operating instruction.

The processor 410 may be a central processing unit (CPU), or may be an application specific integrated circuit (ASIC), or may be one or more integrated circuits configured to implement the embodiment of this application.

The memory 430 is configured to store the program 432. The memory 430 may comprise a high-speed random access memory (RAM) memory, and may further comprise a non-volatile memory, for example, at least one disk memory. The program 432 may specifically comprise:

a user attention behavior detection module, configured to detect an attention behavior of a user towards an application leaderboard to obtain user attention behavior data; and

a ranking threshold determination module, configured to determine a ranking threshold according to the user attention behavior data.

For specific implementation of units in the program 432, reference may be made to corresponding units in the foregoing embodiments, which are not repeated herein.

It is clear to persons skilled in the art that, for convenience and brevity of description, reference may be made to corresponding descriptions in the foregoing apparatus embodiments for specific operating processes of the devices and modules described above, which are not described herein again.

A person of ordinary skill in the art may be aware that, in combination with the examples described in the embodiments disclosed in this specification, units and method steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but such implementation should not be considered beyond the scope of this application.

When implemented in a form of a software functional unit and sold or used as an independent product, the functions may be stored in a computer-readable storage medium. Based on such an understanding, the technical solutions of this application essentially, or the part contributing to the prior art, or a part of the technical solutions may be implemented in a form of a software product. The computer software product is stored in a storage medium and comprises several instructions for instructing a computer device (which may be a personal computer, a server, a network device, or the like) to perform all or a part of the steps of the methods described in the embodiments of this application. The foregoing storage medium comprises: any mediums capable of storing program code, such as a USB flash drive, a removable hard disk, a read-only memory (ROM), a RAM, a magnetic disk, or an optical disc.

The foregoing implementation manners are not used for describing this application rather than limiting this application. A person of ordinary skill in the art may make various variations or modifications without departing from the spirit and scope of this application. Therefore, all equivalent technical solutions also fall within the scope of this application, and the patent protection scope of this application shall be limited by the claims.

1. A method, comprising:
detecting, by a device comprising a processor, an attention behavior of a user towards an application leaderboard to obtain user attention behavior data; and
determining a ranking threshold for the application leaderboard according to the user attention behavior data.

2. The method of claim 1, wherein the user attention behavior data comprises a user identifier and a user attention application quantity.

3. The method of claim 1, wherein the user attention behavior data comprises a user attention application quantity, and
the detecting comprises obtaining the user attention application quantity from a user device.

4. The method of claim 3, wherein the user attention application quantity is a rank of an application, on which a user operation is configured to execute at the user device, on the application leaderboard.

5. The method of claim 1, wherein the user attention behavior data comprises a user attention application quantity, and
the detecting comprises recording a quantity of applications pushed to a user device as the user attention application quantity.

6. The method of claim 5, wherein the user attention application quantity is a lowest rank of an application, and the lowest rank is displayed at the user device on the application leaderboard.

7. The method of claim 1, wherein the user attention behavior data further comprises a user identifier and a user attention application quantity, and
the detecting comprises obtaining the user identifier from a user device or determining the user identifier in response to obtaining the the user attention application quantity.

8. The method of claim 1, wherein the determining the ranking threshold comprises determining the ranking threshold based on a coverage parameter.

9. The method of claim 8, wherein the determining the ranking threshold further comprises setting the coverage parameter.

10. The method of claim 8, wherein a value range of the coverage parameter is 60% to 90% of a value representing full coverage for the coverage parameter.

11. The method of claim 8, wherein the coverage parameter is a coverage proportion of user attention application quantities in the user attention behavior data, and
the determining the ranking threshold comprises determining the ranking threshold so that applications not lower than the ranking threshold on the application leaderboard cover user attention applications having the coverage proportion of the coverage parameter in the user attention behavior data.

12. The method of claim 11, wherein the determining the ranking threshold further comprises:
calculating a total number of the user attention application quantities in the user attention behavior data;
incrementing a value of the ranking threshold from an initial value;
calculating another total number of the user attention application quantities that are covered by a current ranking threshold, in the user attention behavior data;
dividing the other total number by the total number resulting in a ratio value; and
in response to the ratio value being determined to reach the coverage parameter, outputting the ranking threshold.

13. The method of claim 12,
in response to the calculating the other total number of the user attention application quantities,
setting an initial value of the other total number to 0,
sequentially comparing the current ranking threshold and all the user attention application quantities in the user attention behavior data, and
if the current ranking threshold is less than a user attention application quantity, adding the current ranking threshold to the other total number, and
if the current ranking threshold is not less than the user attention application quantity, adding a current user attention application quantity to the other total number.

14. The method of claim 8, wherein the coverage parameter is a coverage proportion of user identifiers in the user attention behavior data, and
the determining the ranking threshold comprises determining the ranking threshold so that applications not lower than the ranking threshold on the application leaderboard cover applications drawing attention of users having the proportion of the coverage parameter in the user attention behavior data.

15. The method of claim 14, wherein the determining the ranking threshold further comprises:
calculating a total number of the user identifiers in the user attention behavior data;
calculating a result of a function of the total number of the user identifiers and a coverage parameter of user identifiers that have been determined to require coverage;
sorting user attention application quantities in the user attention behavior data in an ascending order resulting in sorted user attention application quantities; and
respectively using the sorted user attention application quantities in order as the ranking threshold.

16. A system, comprising:
a memory that stores executable modules; and
a processor, coupled to the memory, that executes the executable modules to perform operations of the system, the executable modules comprising:
a user attention behavior detection module configured to detect an attention behavior of a user towards an application leaderboard to obtain user attention behavior data; and
a ranking threshold determination module configured to determine a ranking threshold applicable to the application leaderboard according to the user attention behavior data.

17. The system of claim 16, wherein the user attention behavior data comprises a user attention application quantity, and
the user attention behavior detection module further comprises a user attention application quantity obtaining unit configured to receive the user attention application quantity from a user device.

18. The system of claim 16, wherein the user attention behavior data comprises a user attention application quantity, and
the user attention behavior detection module further comprises a user attention application quantity obtaining unit configured to record a quantity of applications pushed to a user device as the user attention application quantity.

19. The system of claim 16, wherein the user attention behavior data further comprises a user identifier and a user attention application quantity, and
the user attention behavior detection module further comprises a user identifier obtaining unit configured to obtain the user identifier from a user device or determine the user identifier when the user attention application quantity is obtained.

20. The system of claim 16, wherein the ranking threshold determination module is further configured to determine the ranking threshold based on a coverage parameter.

21. The system of claim 20, wherein the ranking threshold determination module further comprises a coverage parameter setting unit configured to set the coverage parameter.

22. The system of claim 20, wherein the coverage parameter is a coverage proportion of user attention applications, and
the ranking threshold determination module is configured to determine the ranking threshold according to a function that causes applications having values determined to be greater than the ranking threshold on the application leaderboard to comprise the user attention applications having the coverage proportion of the coverage parameter in the user attention behavior data.

23. The system of claim 20, wherein the coverage parameter is a coverage proportion of users paying attention to applications, and
the ranking threshold determination module is further configured to determine the ranking threshold according to a function that causes applications having values determined to be greater than the ranking threshold on the application leaderboard to comprise the applications of the users having the coverage proportion of the coverage parameter in the user attention behavior data.

24. A computer readable storage device, comprising at least one executable instruction, which, in response to execution, causes a system comprising a processor to perform operations, comprising:
detecting an attention behavior of a user towards an application leaderboard to obtain user attention behavior data; and
determining a ranking threshold according to the user attention behavior data.
